(19) United States
(12) Patent Application Publication
(10) Pub. No.: US 2009/0321286 A1
(43) Pub. Date: Dec. 31, 2009

(54) CONTAINER CLOSURE HAVING A LIFTING CAP FOR INTRODUCING AN ADDITIVE INTO THE CONTENTS OF THE CONTAINER

(76) Inventor: Bernard Frutin, Renfrewshire (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 12/309,847

(22) PCT Filed: Aug. 10, 2007
(86) PCT No.: PCT/GB2007/050485

§ 371 Date: Jan. 30, 2009

(30) Foreign Application Priority Data
Aug. 11, 2006 (GB) 0615991.7
Jan. 15, 2007 (GB) 0700732.1

(51) Int. Cl. B65D 25/08; B65D 41/00; B23P 11/00

(52) U.S. Cl. 206/219; 215/316; 29/428

(57) ABSTRACT

A closure device which includes a fluid chamber containing an additive such as a liquid which can be introduced and mixed into a liquid in a container by operation of the closure device. The closure device includes a cap member having a fluid chamber and a housing having a plug member. The cap member may have a cam or follower surface on a lower surface of the cap top wall, which engages with a corresponding cam or follower surface on an upper surface of the housing, to allow the cap member to be lifted relative to the housing from a closed position in which the plug member closes an aperture in the fluid chamber to an open position in which the plug member is at least partially withdrawn from the aperture, thereby allowing the additive to pass from the fluid chamber to the liquid in the bottle.

The present invention relates to a closure device for releasing an additive liquid into a liquid in a container by operation of the closure device and to a container including such a closure device. The invention also relates to a method of assembling a closure device and a method of introducing an additive liquid by means of operating a closure device.

In a number of applications, such as mixtures of different liquids, it may be necessary to release and mix an additive liquid into another liquid shortly before the liquid mixture is used. It may not be possible or desirable to store the liquids in a premixed form, as they may react undesirably with each other when stored as the mixture for a period of time. An example of this may be two component pharmaceuticals which have a longer shelf life when unmixed than they do when mixed. However, it can also apply to other liquids or to mixtures of liquids and gases, such as water, alcoholic beverages, other beverages, and other solvents or solutions. The liquid to which the additive liquid is introduced may be a carbonated or a non-carbonated liquid.

An assembly for releasing an additive liquid into a liquid in a container upon release of a closure from the container is known from the prior art. International Patent Application WO97/05039 discloses a device for releasing a liquid into another liquid held in a container. The known device is for use with containers having releasable closures. The device according to the prior art comprises a fluid chamber for storing a fluid. The fluid chamber is positioned adjacent an opening in the container. The fluid chamber comprises a fluid outlet for releasing fluid into the liquid.

The known device has the disadvantage that the closure must be at least partially opened to enable the mixing of the fluid stored in the fluid chamber with the liquid in the container. Moreover the device is complex to manufacture and requires many parts.

According to a first aspect of the present invention there is provided a closure device for use with a container having a main liquid compartment and an opening with a neck,

the closure device comprising a cap member defining a fluid chamber and a housing having a plug member sealingly engageable in an aperture in a bottom wall of the fluid chamber,
wherein the cap member is provided with a cam means which engages with a corresponding cam means provided on the housing to allow the cap member to be lifted relative to the housing from a closed position in which the plug member closes the aperture to an open position in which the plug member is at least partially withdrawn from the aperture to provide a communication path in use from the fluid chamber to the main liquid compartment.

The housing may include an inner housing wall adapted to fit inside the neck of the opening, and the closure device may include sealing means which seals between the fluid chamber and the inner housing wall. This maintains a seal between the fluid chamber and inner housing wall, and therefore between the fluid chamber and the neck as the cap member and fluid chamber are lifted relative to the housing and container, in both the closed and open positions. The contents of the fluid chamber can thus pass into the main liquid compartment and be mixed, for example by shaking the container without risk of the contents escaping between the closure member and the container.

In one embodiment the cam means on one of the cap member or housing includes a cam surface and the cam means on the other of the cap member or housing includes a follower for co-operation with the cam surface. The cam surface may be in the form of one or more inclined surfaces or ramps and the follower may be in the form of one or more suitably inclined surfaces or ramps so that the cap member is lifted relative to the housing by rotation of the cap member as the follower travels over the cam surface.

Mutual engagement means may be provided so as not allow the cap member and the housing to become completely separated from each other.

The cap member may include a top cap wall on which is provided the cap member cam means, an outer cap wall and an inner cap wall extending from the top cap wall to the bottom wall and arranged inside the outer cap wall. The bottom wall may be formed separately from the remainder of the cap member, which may be formed as a single moulding. The cap member cam means may be provided on a lower surface of the top cap wall between the outer cap wall and the inner cap wall.

The fluid chamber may be defined by the top cap wall, the inner cap wall and the bottom wall.

The outer housing wall may be provided with an internal secondary thread adapted in use to engage with an external secondary thread provided on a neck of an opening of the container. Thus in use the outer housing wall is screwed onto the outside of the neck.

The housing may further comprise an inner housing wall arranged inside the outer housing wall and provided with internal sealing means to seal against an outer surface of the inner cap wall and external sealing means to seal against an internal surface of the neck of the opening. The inner housing wall may be connected to the outer housing wall by a web which sits on top of the neck in use. The housing cam means may be provided on an upper surface of the web, or any other upward facing part of the housing, such as the top of the inner housing wall.

The outer cap wall may be provided with engagement means, such as a bead, which engages with corresponding engagement means, such as a groove, in the outer housing wall. The outer housing wall may be provided with a first engagement means which engages with the outer cap wall engagement means in the closed position and a second engagement means which engages with the outer cap wall engagement means in the open position.

The housing may further comprise a frame which supports the plug member so that the plug member is arranged inside the inner housing wall and extends upwardly towards the fluid chamber in use. The frame may include apertures allowing fluid passage therethrough, to avoid the creation of a vacuum between the fluid chamber and housing, so that the housing is free to slide relative to the cap member when the cap member is inserted into or withdrawn from the housing. The apertures also discourage liquid from lying in the frame after firing which minimise any residue of liquid in the frame.

The plug member may include a nozzle directed away from the fluid chamber.

The plug member may include a cylindrical outer surface which engages with a sealing means provided in the bottom wall. The sealing means may be capable of holding pressurised fluid in the fluid chamber when this fluid is at higher pressure than the contents of the container.

The sealing means may comprise an upper seal which seals against the cylindrical outer surface of the plug member when the cap member is in the closed position and which allows the passage of fluid between the upper seal and the plug member when the cap member is in the open position.

The sealing means may comprise a lower seal which seals against the cylindrical outer surface of the plug member when the cap member is in the closed and open positions. This ensures that in the open position pressurised fluid can only escape into the container through the communication path and nozzle, and does not leak around the plug member.

The plug member may include an internal fluid passage which extends to the cylindrical outer surface at a position below the upper seal when the cap member is in the closed position, the internal fluid passage being in communication with the nozzle.

The cap member may include an anti-tamper ring provided on the cap member to prevent rotation of the cap member relative to the housing without at least partial removal of the anti-tamper ring.

The anti-tamper ring may comprise an extension of the outer cap wall connected to the outer cap wall by a perforated neck portion, the extension being provided with a flange which engages beneath the outer housing wall to prevent lifting of the cap member relative to the housing.

The cap member and housing cam means may include mutually engageable detent means to prevent the rotation of the cap member relative to the housing beyond a predetermined limiting angle of rotation. When the cap member is rotated, it initially rotates relative to the housing, but once the detent means engage the cap member and housing rotate together.

The housing may include an anti-tamper device which prevents rotation of the cap member and housing relative to the neck of the container until a predetermined torque is applied to the cap member.

The anti-tamper device may comprise an extension of the outer housing wall connected to the outer housing wall by at least one neck portion of reduced cross-sectional area relative to the outer housing wall, the extension being provided with a detent means adapted to engage in use with a detent means provided on the neck of the container to prevent lifting of the housing relative to the neck without rupture of the at least one neck portion.

The fluid chamber may contain an additive liquid and a head space of pressurised gas.

According to a second aspect of the present invention there is provided a container having a main liquid compartment, an opening having a neck, and a closure device closing said opening, wherein the closure device comprises a cap member defining a fluid chamber and a housing secured to the neck of the container, the housing having a plug member sealingly engageable in an aperture in a bottom wall of the fluid chamber, wherein the cap member is provided with a cam means which engages with a corresponding cam means provided on the housing to allow the cap member to be lifted relative to the housing from a closed position in which the plug member closes the aperture to an open position in which the plug member is at least partially withdrawn from the aperture to provide a communication path in use from the fluid chamber to the main liquid compartment.

The housing may include an inner housing wall arranged inside the neck of the opening and the closure device may include sealing means which seals between the fluid chamber and the inner housing wall. This maintains a seal between the fluid chamber and inner housing wall in both the closed and open positions.

The cam means on one of the cap member or housing member may include a cam surface and the cam means on the other of the cap member or housing may include a follower for co-operation with the cam surface. The cam surface may be in the form of one or more inclined surfaces or ramps and the follower may be in the form of one or more suitably inclined surfaces or ramps so that the cap member is lifted relative to the housing by rotation of the cap member as the follower travels over the cam surface.

The main liquid compartment may contain a primary liquid, which may contain water or be a beverage. However the primary liquid could be an alcoholic beverage, a cosmetic preparation, a pharmaceutical product, a dairy product or an agricultural feed or other product, or any other suitable liquid or semi-liquid substance.

The fluid chamber may contain an additive liquid and a head space of pressurised gas.

The cap member may include a top cap wall on which is provided the cap member cam means, an outer cap wall and an inner cap wall extending from the top cap wall to the bottom wall and arranged inside the outer cap wall. The bottom wall may be formed separately from the remainder of the cap member, which may be formed as a single moulding. The cap member cam means may be provided on a lower surface of the top cap wall between the outer cap wall and the inner cap wall.

The fluid chamber may be defined by the top cap wall, the inner cap wall and the bottom wall.

The outer housing wall may be provided with an internal secondary thread adapted in use to engage with an external secondary thread provided on a neck of an opening of the container. Thus in use the outer housing wall is screwed onto the outside of the neck.

The housing may further comprise an inner housing wall arranged inside the outer housing wall and provided with internal sealing means to seal against an outer surface of the inner cap wall and external sealing means to seal against an internal surface of the neck of the opening. The inner housing wall may be connected to the outer housing wall by a web which sits on top of the neck in use.

The housing cam means may be provided on an upper surface of the web.

The housing may further comprise a frame which supports the plug member so that the plug member is arranged inside the inner housing wall and extends upwardly towards the fluid chamber in use.

The plug member may include a nozzle directed away from the fluid chamber.

The plug member may include a cylindrical outer surface which engages with a sealing means provided in the bottom wall.

The sealing means may comprise an upper seal which seals against the cylindrical outer surface of the plug member when the cap member is in the closed position and which allows the passage of fluid between the upper seal and the plug member when the cap member is in the open position. The sealing means may comprise a lower seal which seals against the cylindrical outer surface of the plug member when the cap member is in the closed and open positions.

The plug member may include an internal fluid passage which extends to the cylindrical outer surface at a position below the upper seal when the cap member is in the closed position, the internal fluid passage being in communication with the nozzle.

According to a third aspect of the invention there is provided a method of assembling a closure device containing additive liquid for introduction into a main liquid compartment of a container, the method comprising providing a cap member,

securing a bottom wall to said cap member to define a fluid chamber, inverting the cap member and introducing an additive liquid into the fluid chamber through an aperture in the bottom wall,
providing a housing having a plug member,
attaching a housing to the cap member by relative axial movement of the housing and cap member so that the plug member enters and closes the aperture in the bottom wall of the fluid chamber.

An inner housing wall of the housing may enclose and seal against the fluid chamber.

The relative axial movement of the housing and cap members may be accomplished by co-operation between a cam surface on one of the cap member or housing with a follower on the other of the cap member or housing.

The method may include the further step of purging the fluid chamber before introduction of the additive liquid, for example purging with nitrogen or any other suitable gas.

The method may include the further step of pressurising the fluid chamber.

The pressurising step may be accomplished by providing pressurised fluid to a passage in said plug member, the passage being in communication with a valve means which prevents release of the pressurised fluid from the fluid chamber. The valve means may comprise a seal which engages with the plug member when the aperture is closed by the plug member. The upper seal may be arranged to function as a flap valve such that it will allow the introduction of pressurised fluid into the fluid chamber, but once pressurised the seal is urged against the plug member to seal the fluid chamber closed. The pressurising step may be accomplished by scavenging pressurised gas from pressurised contents of the main liquid compartment of the container, after the closure device has been secured to the container.

The pressurised fluid may be a gas forming a head space in the fluid chamber of between 6% and 60% of the volume of the fluid chamber.

The step of securing the bottom wall to the cap member may include sealing the bottom wall to a free edge of an inner cylindrical wall of the cap member.

The method may include the further step of securing the closure device to a neck of a container having a main liquid compartment by engagement of an internal thread on the housing with an external thread on the neck of the container.

The cap member may be a push fit onto the closure device to lock the cap member onto the closure device. Alternatively or additionally, the closure device may be a push fit onto the neck of a container to lock the closure device onto the container.

According to a fourth aspect of the invention there is provided a method of introducing an additive liquid into a main liquid compartment of a container, the method comprising the steps of:

raising by action of mutually engaging cam means a cap member of a closure device and a fluid chamber defined by said cap member relative to a housing,
causing a plug member provided on said housing to move relative to the cap member from a closed position in which an aperture provided in a bottom wall of said fluid chamber is closed by said plug member to an open position in which the plug member is at least partially withdrawn from the aperture to provide a communication path from the fluid chamber to the main liquid compartment,
releasing pressurised liquid from said fluid chamber along said communication path into said main liquid compartment, and rotating the cap member further to remove the cap member and housing from the container.

During the raising of the fluid chamber relative to the housing a seal may be maintained between the fluid chamber and an inner housing wall of the housing arranged in the neck of the container.

The cap member may be raised by rotating the cap member such that the fluid chamber is raised by cam action between a first cam means provided on the cap member and a second cam means provided on the housing.

The cap member may be rotated by a first angle of between 0° and 90°, optimally about 45°, from the closed position to the open position. Further rotation of the cap member may be limited to a second angle of between 0° and 90°, optimally about 45°, by the mutual engagement of detent means provided on the cap member and housing. The second angle may be predetermined by the position of the detent means. It is selected so that it is sufficient to ensure opening of the plug member and consequent mixing of the additive liquid, allowing for manufacturing tolerances.

During the raising of said cap member relative to the housing, a sealing means may seal between an external surface of the inner cap wall and an internal surface of the inner housing wall.

The method may further include the step of at least partially removing an anti-tamper ring provided at the outer cap wall, thereby allowing rotation of the cap member relative to the housing.

The method may further include the step of applying sufficient torque to the cap member, during the step of rotating the cap member further to remove the cap member and housing from the container, to remove an anti-tamper device.

The invention will be described, by way of example only, with reference to the drawings in which:

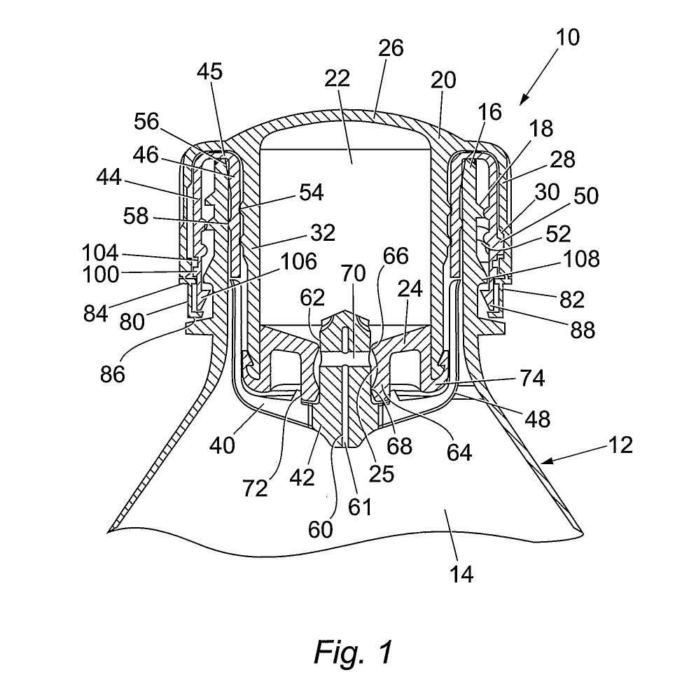

FIG. 1 shows a cross-section through a closure device secured to the neck of a container;

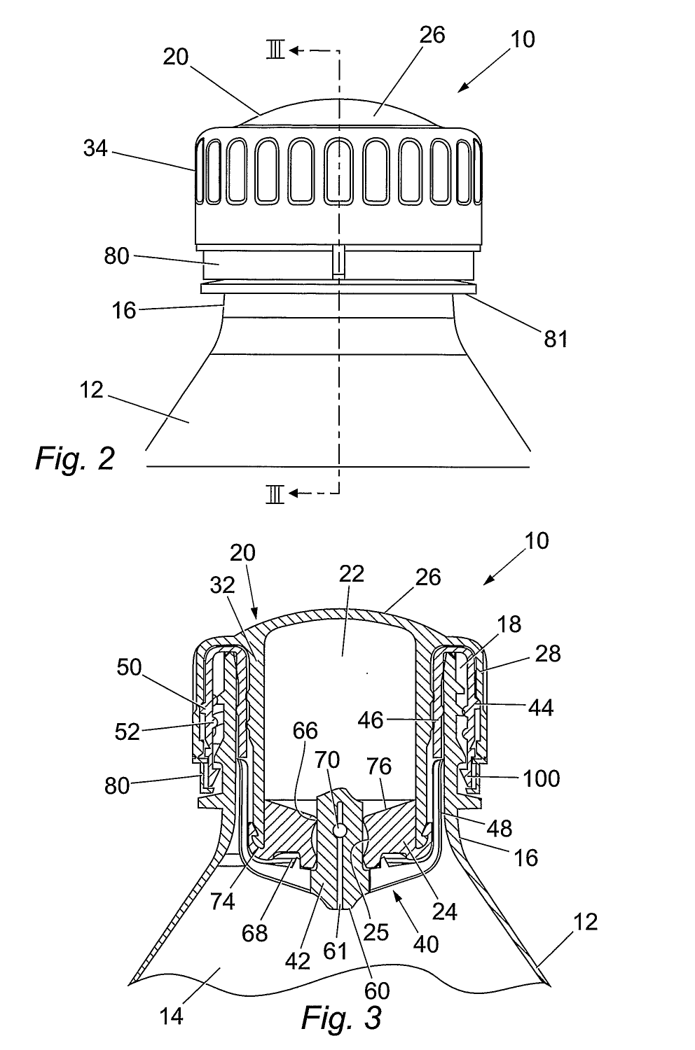

FIG. 2 shows a side elevation of the closure device of FIG. 1;

FIG. 3 is a cross-section on line III-III in FIG. 2;

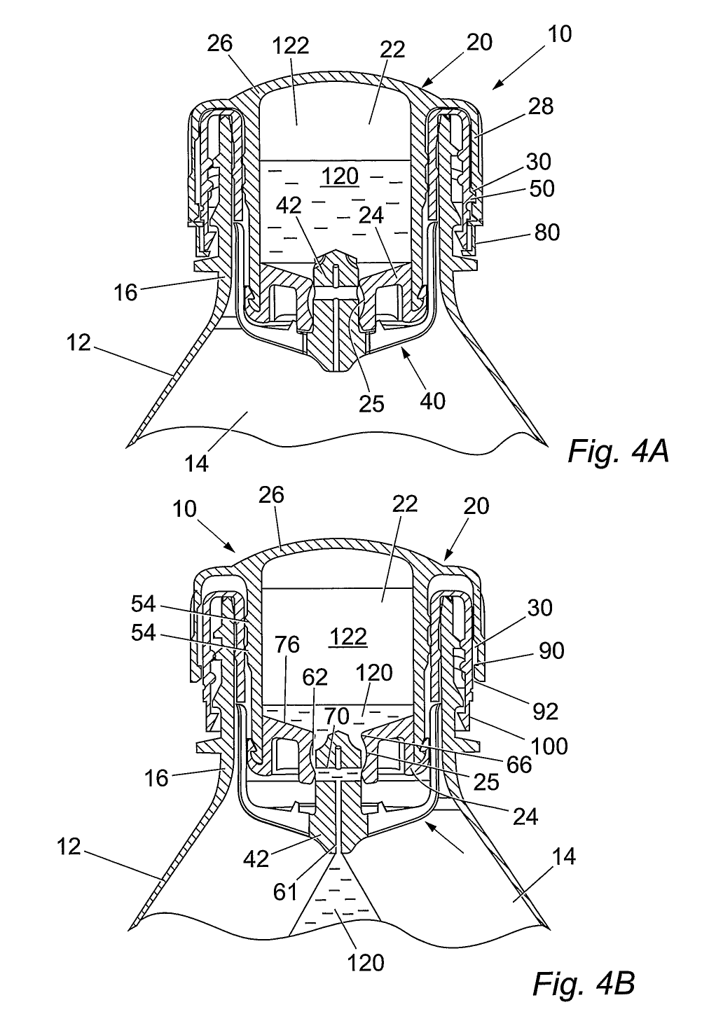

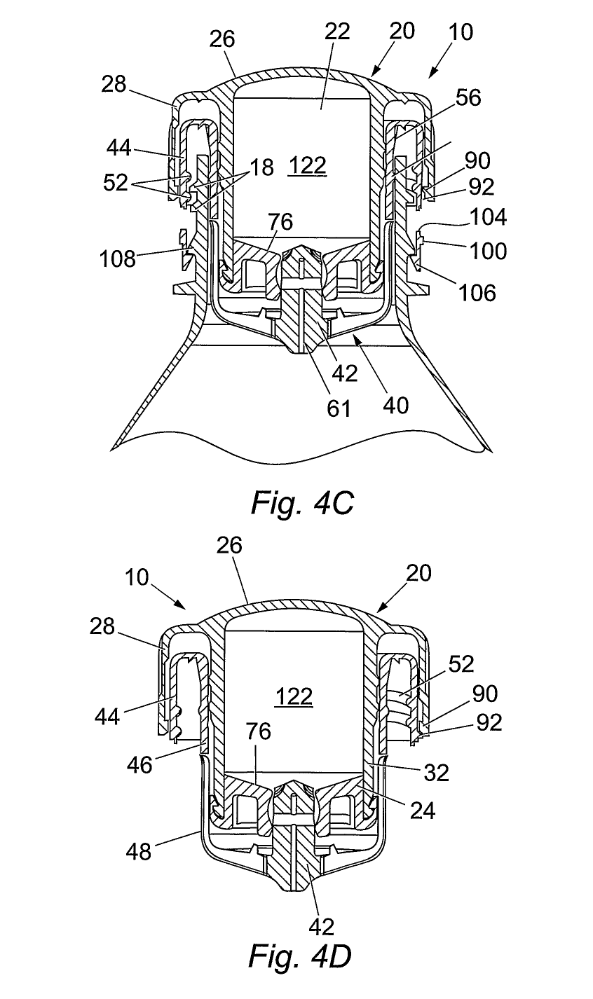

FIGS. 4A, 4B, 4C and 4D are sequential cross-sectional drawings showing the operation of the closure device of FIG. 1 to introduce additive liquid into a container and to remove the closure device from the container;

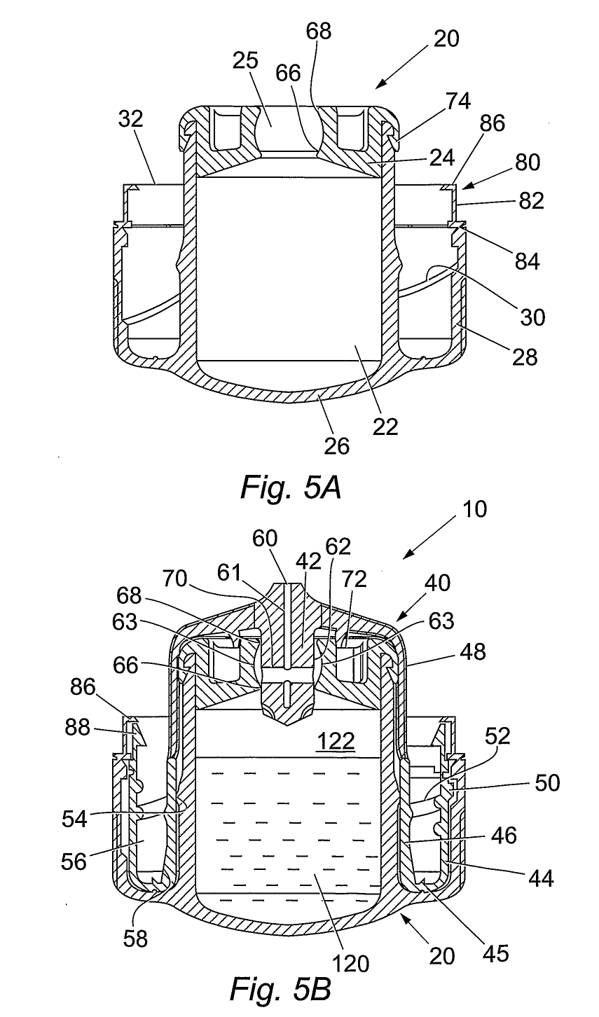

FIGS. 5A and 5B are sequential cross-sectional drawings showing the assembly and filling of the closure device of FIG. 1;

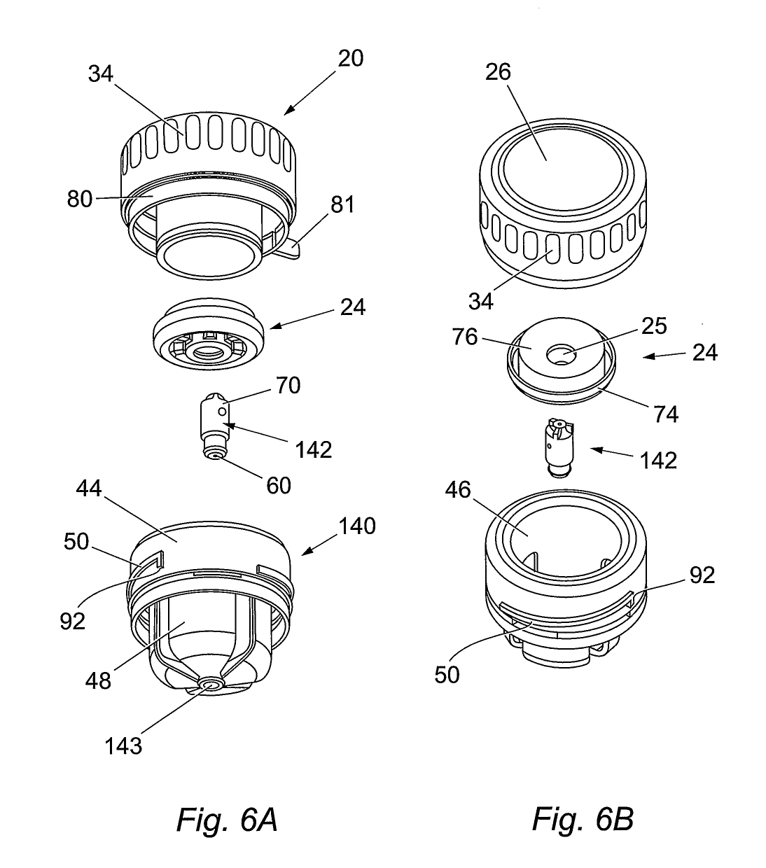

FIGS. 6A and 6B are views from below and above respectively of the components of a modified closure device according to FIG. 1;

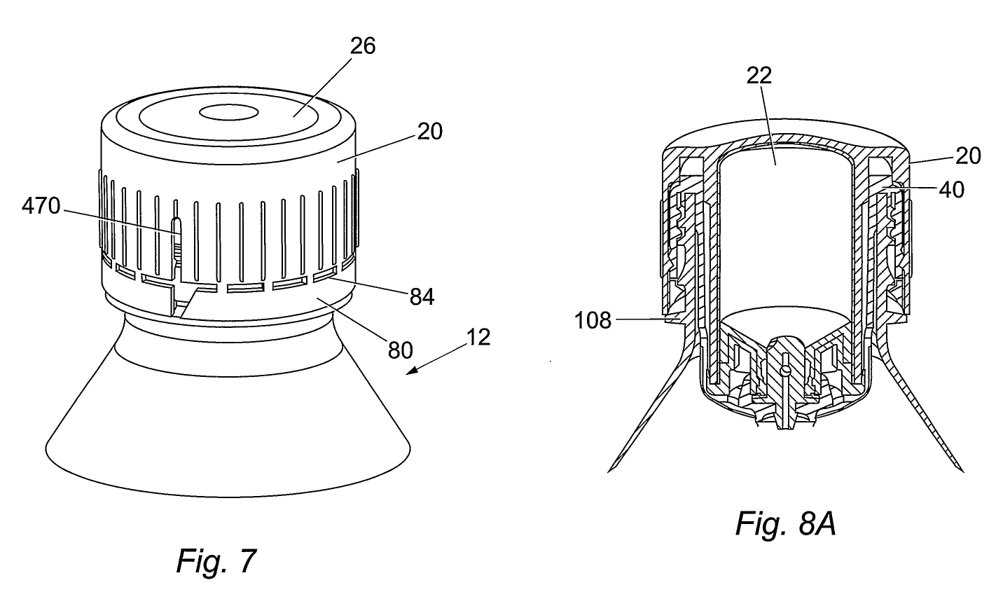

FIG. 7 is a schematic perspective view from above of a further embodiment of a closure device;

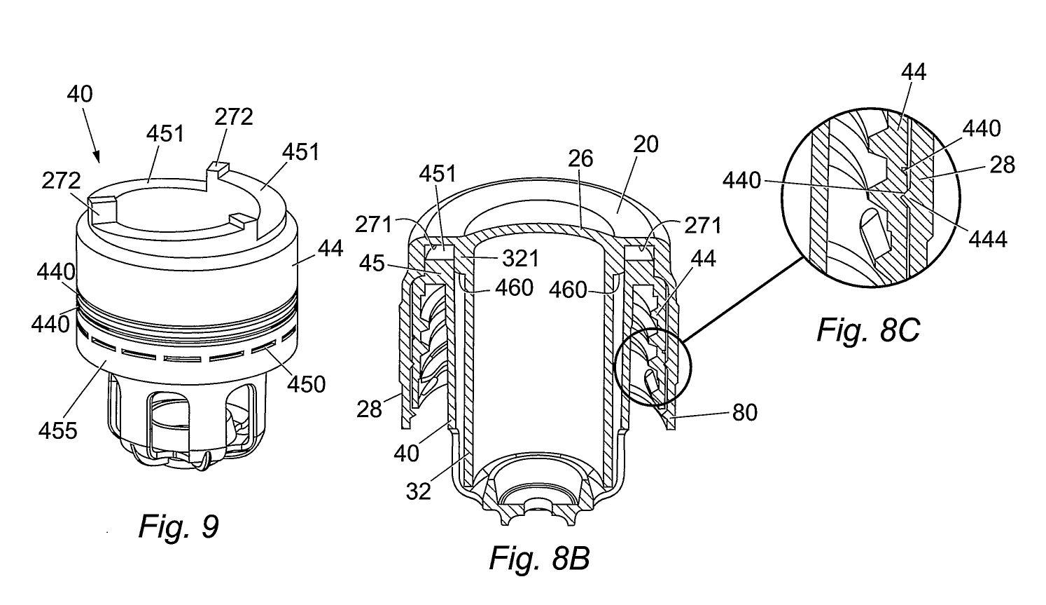

FIGS. 8A, 8B and 8C are cross-sections through the closure device of FIG. 7; and

FIG. 9 is a perspective view from one side of the alternative housing of FIG. 7.

FIGS. 1 to 6 illustrate the operation of the closure device according to the invention. In the embodiments of FIGS. 1 to 6 an internal primary thread 30 and external primary thread 50 enable lifting of the cap member 20 relative to the housing 40. In the embodiments of FIGS. 7 to 9 mutually engaging cam means 251, 471 instead enable lifting of the cap member 20 relative to the housing 40. However the detailed operation of the embodiment of FIGS. 7 to 9 will become apparent from the description of the embodiments of FIGS. 1 to 6.

With reference to FIGS. 1 to 3 there is shown a closure device 10 together with the upper part of a container 12. The container is a standard PET bottle having a main liquid compartment 14 and a standard 30 mm neck 16 with an external thread 18. For the purposes of this invention the thread is described as a secondary thread 18.

The closure device 10 comprises two main parts, a cap member 20, which defines a fluid chamber 22, and a housing 40. The cap member 20 includes a bottom wall 24, which although it may be made of a different material is secured to the remainder of the cap member 20 to form a unitary member. An aperture 25 is provided in the bottom wall 24. The cap member 20 includes a top cap wall 26, an outer cap wall 28, and an inner cap wall 32, which may all be formed as a single moulding from polypropylene or any other suitable plastic. The outer cap wall includes an internal primary thread 30 adapted to engage a corresponding external primary thread on the housing 40, as will be described below. Together the internal and external primary threads form part of the primary engagement means which allow the cap member 20 to be lifted relative to the housing 40. The outer cap wall 28 also includes surface depressions 34 on the outer surface to aid gripping of the outer cap wall. Any suitable surface features may be provided instead of the depressions 34 shown.

The housing 40 is also preferably formed as a unitary polypropylene moulding, although it can be formed from any other suitable material. It comprises a plug member 42 arranged on the central axis of the closure member 10, an outer housing wall 44 adapted to fit outside the neck 16, a web 45 which sits on top of the neck 15, an inner housing wall 46 which extends down from the web 45 inside the neck and which seals against the neck 10, and a frame 48 which extends from the inner housing wall 46 and supports the plug member 42.

The outer housing wall 44 has an external primary thread 50 which engages the internal primary thread 30 on the cap member as part of the primary engagement means. It also has an internal secondary thread 52 which engages the external secondary thread 18 on the neck 16 of the container.

Internal sealing means 54 are provided to seal between the inner cap wall 32 and the inner housing wall 44. In the illustrated example the internal sealing means 54 are formed as ribs on the outer surface of the inner cap wall, but they could be formed as ribs on the inner surface of the inner housing wall, or as any other suitable sealing means. The internal sealing means 54 prevents the contents of the container 12 passing between the inner cap wall 32 and the inner housing wall 44 during storage and while the cap member 20 is raised relative to the housing 40, as later described.

External sealing means in the form of a taper 56 and rib 58 are provided to seal between the inner housing wall 44 and the neck 16 of the container 12. Such seals are well known in the art and serve to prevent the contents of the container 12 passing between the inner housing wall 44 and the neck during storage. A taper seal may be used for the internal sealing means 54 also.

The plug member 42 has a nozzle 60 extending below it. A nozzle passage 61 is provided to convey pressurised liquid from the fluid chamber 22 when the closure device is opened. The plug member 42 is formed with a cylindrical outer surface 62, which engages sealingly with sealing means 64 provided at the aperture 25 in the bottom wall 24. In the example the sealing means comprises an upper seal 66 which when the plug member 42 is in the closed position of FIG. 1 engages with the cylindrical outer surface 62 above an internal fluid passage 70, while a lower seal 68 engages with the cylindrical outer surface 62 below the an internal fluid passage 70.

The upper surface 76 of the bottom wall 24 slopes towards the plug member 42, so that all the liquid is drained from the fluid chamber 22 when the plug member is in the open position. The lower seal 68 is held by a collar 72 provided on the frame 48 which urges the lower seal 68 against the plug member 42.

In the illustrated example the bottom wall 24 includes a flange 74 which locks onto a corresponding flange at the edge of the inner cap wall 32 when the cap member is assembled. However any other suitable method of vapour-tight connection may be used, such as laser welding.

At the lower edge of the outer cap wall 28 is an anti-tamper strip 80, with a tab 81 which can be pulled to remove the strip. The strip is an extension 82 of the outer cap wall 28, connected by a neck portion 84, and engaging the underside 88 of the outer housing wall 44 by a detent flange 86. Such anti-tamper strips are known in the art and are not described further. Until the anti-tamper strip 80 is at least partially removed, the cap member 20 cannot be unscrewed from the housing 40. Once the anti-tamper strip 80 is at least partially removed the cap member 20 can be unscrewed from the housing 40 by interaction of the internal thread 30 on the cap and the external thread 50 on the housing. The threads include mutually engaging detent means 90, 92, best seen in FIG. 4, which serve to limit the relative rotation of the cap member 20 and housing 40. It is to be understood that any suitable mutually engaging shape or protrusion may be used to limit this movement. The anti-tamper strip may be replaced by any other suitable anti-tamper means, or may be omitted.

At the lower edge of the outer housing wall 44 is provided a further anti-tamper device 100. The device is an extension 102 of the outer housing wall 44, connected by one or more neck portions 104, and includes a detent flange 106 which engages a corresponding detent means 108 provided on the container neck 16. Such anti-tamper devices are known in the art and are not described further. A predetermined torque applied to the cap member 20 is required to break the neck portions 104 and allow the housing 40 to be raised on the secondary threads 18, 52 relative to the neck 16. The anti-tamper device 100 remains on the neck 16 of the container 12 below the detent 108. Any other suitable anti-tamper device may be used instead, or it may under certain circumstances be omitted.

FIGS. 4A to 4D show the operation of the closure device of the invention.

In FIG. 4A the closure device 10 is secured to a container 12 containing a primary liquid (not shown), for example water in its main liquid compartment 14. The fluid chamber 22 in the cap member contains a liquid additive 120 and a head space 122 of pressurised gas. The closure device 10 is in the closed position, in which the fluid chamber 22 is sealed closed by the plug member 42 which is engaged in the aperture 25 in the bottom wall 24. The housing 40 is screwed fully onto the neck 16 through the secondary threads 18, 52, and the cap member 20 is screwed fully onto the outer housing wall 44 through the internal and external primary threads 30, 50. The contents of the container 12 may be at atmospheric pressure, or may be pressurised to a pressure less than that of the fluid chamber 22. There is a seal 54 provided between the fluid chamber 22 and inner housing wall 46, and further seals are provided between the inner housing wall 46 and the neck 16 so that the contents of the container are sealed from the external atmosphere.

To trigger the firing of the liquid additive 120 into the main liquid compartment 14 of the container 12, the cap member 20 must be unscrewed relative to the housing 40 to the position shown in FIG. 4B, through a first angle of 45° according to the preferred embodiment. However it is to be understood that this first angle may be any desired angle by appropriate selection of the thread and pitch. First the anti-tamper strip 80 is at least partially removed so that the outer cap wall 28 is free to be raised relative to the outer housing wall 44. Then the cap member 20 is grasped and rotated. The primary threads 30, 50 have a relatively large thread angle, so that a relatively large vertical displacement is effected by a relatively small rotation. As the cap member rises, the fluid chamber 22 is lifted away from the plug member 42. When the upper seal 66 of the bottom wall 24 passes above the top of the plug member 42, as shown in FIG. 4B, the main liquid compartment 14 comes into fluid communication with the fluid chamber 22, and the pressurised additive liquid 120 is free to pass between the upper seal 66 and the outer surface 62 of the plug member 42, into the internal fluid passage 70, along the nozzle passage 61 and out of the nozzle 60 into the main liquid compartment 14. The lower seal 68 in the bottom wall 24 continues to seal between the bottom wall 24 and the plug member 42, so that the additive liquid 120 cannot leak into the main liquid compartment 14 along any other path. Typically the primary thread 30, 50 is a standard 30/25 PET bottle thread with 9 mm pitch, of the type used with PET water bottles, and the closure device 10 is arranged so that the additive liquid 120 is fired into the main liquid compartment 14 when the cap member is rotated through 45° from the closed position under optimum tolerance. In practice this angle could be smaller or greater, in the range 0° to 90°.

The volume of the head space 122 is chosen to be sufficiently large so that all the additive liquid 122 is expelled into the main liquid compartment 14. The top surface 76 of the bottom wall 24 slopes down towards the aperture 25, so that under gravity all the additive liquid flows to the aperture. The upper end of the plug member 42 is also shaped to ensure that any liquid thereon drains to the perimeter of the plug member 42.

Referring now to FIG. 4C, following release of the additive liquid 120, the cap member 20 is rotated further through a second angle of 45° according to the preferred embodiment, until the mutually engageable detent means 90, 92 on the cap 20 and housing 40 engage with each other and prevent further relative rotation. Typically this happens when the cap member 20 is rotated through a total of 90° from the closed position. At this point the torque on the cap member 20 is transferred to the outer housing wall 44 and the housing 40 begins to rotate relative to the container neck 16. In the illustrated embodiment an anti-tamper device 100 is provided on the housing 40, so an increase torque must be applied to first break the neck portions 104 of the anti-tamper device 100 before the housing can be raised relative to the container 12 by engagement of the secondary threads 18, 52. The secondary threads 18, 52 are typically MCA2 threads of 3.2 mm pitch. FIG. 4C shows the closure device in a partially raised position. As the cap member 20 is rotated, the entire closure device 10 is lifted from the container 12, until it is as shown in FIG. 4D, removed from the container 12.

If required, the closure device 10 can be screwed back onto the container 12, to close the container. As the cap member is rotated, the cap member 20 will rotate back to its original position relative to the housing 40, and then the cap member 20 and housing 40 will rotate together on the external secondary thread 18 provided on the neck 16, until they can be rotated no further and the container 12 is sealed closed.

Referring to FIGS. 5A and 5B, there is shown a method of assembling a closure device 10 according to the invention. The cap member 20, without the bottom wall 24, is formed by moulding from polypropylene for example. The housing 40 is also formed separately by moulding from polypropylene for example.

The bottom wall 24 is shown in more detail in FIG. 10. It can be formed of any suitable material and is formed so that it can be readily secured to the inner cap wall 32 of the cap member 20 to form the fluid chamber 22. Although it can be formed of one material, in FIG. 10 it is shown formed from two materials, a frame 77 of a relatively rigid plastic and a sealing portion of relatively flexible material. In the example of FIG. 10 there is a first sealing portion 64 of softer sealing material to provide the upper and lower seals 66, 68 which engage with the plug member 42. There is also a second sealing portion 78 which provides a secure seal against the inner face of the inner cap wall 32. The frame 77 provides the structural strength and rigidity required of the bottom wall 24 to resist the pressure arising from the pressurised fluid chamber 22 in use. Because the material of the frame 77 is relatively strong and stiff, weight may be saved by forming cut-outs 79. A suitable technique for manufacturing the bottom wall 24 is inset moulding, in which the frame 77 is first formed by moulding and then is placed in a second mould and has the sealing portions 64, 78 formed around it. Suitable materials for the sealing portion are natural or synthetic rubber or thermoplastic elastomers. Suitable materials for the frame are metal or rigid plastics.

The bottom wall 24 is secured to the inner cap wall 32 by any appropriate technique, for example by engagement of a detent flange 74 on a corresponding groove in the external face of the inner cap wall 32, or by laser, sonic or spin welding. The fluid chamber 22 is then defined by the bottom wall 24, the top cap wall 26 and the inner cap wall 32.

The cap member 20 is placed in the inverted position shown in FIG. 5A and, after purging with nitrogen or other suitable purging means to remove contaminants, the additive liquid 120 is then introduced into the fluid chamber 22 through the aperture 25 in the bottom wall 24.

The housing 40 is then placed on the cap member 20 by engagement of the external primary thread 50 on the housing 40 with the internal primary thread 30 on the cap member 20 so that the plug member 42 enters and closes the aperture 25 in the bottom wall 24, thereby sealing the additive liquid 120 in the fluid chamber 22, as shown in FIG. 5B.

The fluid chamber 22 may be pressurised either at the time of filling or at any other time before using the closure device 10 to close a container 12. The pressurising step may be accomplished by providing pressurised gas to the nozzle passage 61. The nozzle passage 61 is in communication with an internal fluid passage 70 which exits on the cylindrical outer surface 62 of the of the plug member 42, and so is in communication with the volume 63 between the upper 66 and lower seals 68. The lower seal 68 is held against the plug member 42 by a collar 72 on the housing 40, and continues to seal against the plug member 42 even when the volume 63 is pressurised. The upper seal 66 provides a one-way valve means to enable the fluid chamber 22 to be pressurised. The upper seal 66 functions as a flap valve. When the pressure in the volume 63 is greater than the pressure in the fluid chamber 22 the upper seal is urged away from the plug member 42 so that pressurised gas can flow from the volume 63 past the upper seal 66 to the fluid chamber 22. When the source of pressurised gas is removed, and the pressure in the volume 63 and the nozzle passage 61 reverts to atmospheric pressure, the upper seal 66 is urged against the plug member 42 to seal the fluid chamber 22 closed.

Typically the gas forms a head space 122 in the fluid chamber 22 of between 0% and 60% of the volume of the fluid chamber 22.

After the fluid chamber 22 has been pressurised, the closure device 10 is secured to the neck 16 of a container 12 by engagement of the internal secondary thread 52 on the housing 40 with the external secondary thread 18 on the neck 16 of the container, to seal the contents of the container.

In an alternative embodiment, when used with a pressurised container 10, for example a container containing a carbonated beverage, the fluid chamber need not be pressurised before securing to the neck of the container. The internal pressure of a carbonated beverage may be typically 310 kPa (45 psi), and the one-way valve described above will allow the fluid chamber 22 to reach the same pressure. If the pressure in the main liquid compartment 14 is temporarily increased further, for example to 480 kPa (70 psi) by pasteurisation, then the pressure in the fluid chamber 22 will also reach this pressure by scavenging pressure from the head space in the main liquid compartment 14 through the one-way valve. However when the pressure in the main liquid compartment 14 reverts to its previous pressure, say 310 kPa (45 psi), the pressure in the fluid chamber 22 will remain at the higher pressure, say 480 kPa (70 psi) because the seal 66 will prevent the flow of fluid from the fluid chamber 22. If the headspace 122 in the fluid chamber 22 is sufficiently large, this pressure difference will be sufficient to fire the liquid additive on operation of the closure device.

Although the plug member 42 may be formed as a unitary moulding with the remainder of the housing 40, FIGS. 6A and 6B illustrate an alternative embodiment in which the plug member 142 is formed separately and inserted by a snap fit into an aperture 143 provided in the housing. Other components of the closure device are the same as those illustrated with respect to FIGS. 1 to 5 and so are not described further. The plug member 142 may be formed of a different material to the remainder of the housing 142. This is of benefit if the housing material is incompatible with the liquid additive 120, and it is desired to make the plug member 142 of a different material which is compatible, since the plug member 142 remains in contact with the liquid additive 120 during storage. The plug member 142 may be made of metal or any suitable moulded plastic material. Such a plug member may also be used in the embodiments of FIGS. 7 to 9.

FIGS. 7 to 9 show a further embodiment of the invention in which parts which are the same as those described with reference to FIGS. 1 to 6 are denoted by the same reference sign.

The embodiment of FIGS. 7 to 9 differs in part from the embodiment of FIGS. 1 to 5 in that the lifting means between the cap member and the housing is provided by cam means, in the form of one or more inclined surfaces 451 on the upper surface of the web 45 of the housing and one or more co-operating inclined surfaces 271 on the underside of the cap member between the top cap wall 26 and the outer cap wall 28.

Each inclined surface may terminate at a raised detent 272 which projects from the upper surface of the housing as shown in FIG. 9. One or more corresponding depending detents (not shown) may be provided on the underside of the cap member to engage with the projecting detents to prevent rotation of the cap member relative to the housing beyond a predetermined angle of rotation.

In one preferred embodiment a 2 mm vertical travel is envisaged on a 6 mm pitch.

The housing 40 is provided with one or more grooves 440 in the outer wall 44. In the embodiment shown, two grooves are provided about 2 mm apart. A co-operating annular bead 444 is formed in the inner surface of the outer cap wall 28 which corresponds in position to the lower groove in the housing when the cap member is secured on the housing. The bead 444 and grooves 440 provide corresponding engagement means between the cap member 20 and the housing 40.

The lower part of the outer wall of the housing is connected to the main part of the outer wall of the housing via a perforated ring 450 which acts as a tamper evident strip 455 in a known manner such that when the housing is rotation upon the neck of the container the ring is fractured.

In the embodiment shown an internal seal 460 is formed by the upper part 321 of the outer surface of the inner cap wall 32 which rests against the inner surface of the inner housing wall and pushes against the wall of the container in use. In embodiments where a pressurised head space is provided above the liquid in the container, a seal (not shown) is also provided on the underside of the web 45 to assist in reducing the head space pressure before firing of the liquid additive into the container.

One or more slits 470 are provided in the outer cap wall 28. In the embodiment shown a single slit is provided but a plurality of spaced slits may be used. Preferably three slits are provided which may be equispaced around the cap member. The slit or slits are formed above the tamper evident strip 80 and their function will be described further below.

In this embodiment, the cap member may be placed on the housing and pushed into sealing engagement therewith prior to use. In this condition, the bead 444 engages into the lower groove in the outer casing wall and the tamper evident strip 80 covers the lower edge of the tamper evident strip 455 of the casing and extends to the detent 108 of the neck of the container.

Once the anti-tamper strip 80 is removed, rotation of the cap member in this embodiment causes the inclined surfaces 271 of the cap member to travel over the inclined surfaces 451 of the housing thereby lifting the cap member due to cam action relative to the housing and thus triggering firing of the liquid additive 120 into the main liquid compartment 14 of the container 12 within the first 120 degrees of rotation.

As the cap member lifts, the one or more slits 470 have a sufficient length to allow the outer cap wall 28 to deform sufficiently such that the bead 444 is pulled upward out of the lower groove and keys into the upper groove before the detents 272 on the web and the cap member engage. Thus the cap is prevented from further rotation relative to the housing.

This operation is enabled because the torque generated between the inclined surfaces 451 and 271 overcomes the forces which keep the bead 444 in the lower groove.

As the cap member can no longer rotate relative to the housing, further rotation of the cap member together with the housing breaks the tamper evident strip 455 of the housing to enable the housing to be removed with the cap member.

This embodiment offers a closure having a reduced outer diameter compared to the embodiment of FIGS. 1 to 6 by removing the internal primary thread 30 on the outer cap wall and the external primary thread 50 on the housing 40. This reduction in diameter may allow for an increase in the height of the closure member without significantly increasing the amount of material required and thereby leads to an increase in the volume of the fluid chamber. It is envisaged that the volume of the tank may be around 6-7 ml.

The embodiment shown in FIGS. 7 to 9 is particularly suitable for use where there is no pressurised head space above the liquid in the container. In another embodiment (not shown) where the head space is pressurised and it is necessary to release the pressure in the head space before firing, the seal between the casing and the cap member is removed and one or more breaks are incorporated into the annular bead in order to provide a passage for the escape of the pressurised gas.

The present invention provides a closure device which requires fewer components than prior art devices. The closure device is simple to manufacture, as in one embodiment it requires only three moulded components, the cap member body 20, the cap member bottom wall 24 and the housing 40. The closure device can be assembled and filled with the liquid additive 120 and then stored or transported before use on a standard container 12. It does not require separate filling at the bottling location.

The closure device allows introduction and mixing of the liquid additive 120 into the contents of the main liquid compartment 14 of a container 12 without removal of the closure device 10 from the container 12.

The closure device can be used with any standard container 12, of any shape or volume, of any material, for example PET, glass, metal or any suitable plastic. The external secondary thread 18 on the neck 16 of the container 12 can be any standard thread.

The closure device optimises use of the volume within the neck 16 of the container 12, since the fluid chamber extends across the whole available area of the neck 16. The internal diameter of the fluid chamber 22 is limited only by the thickness of the inner housing wall 46 and the inner cap wall 32. The volume of the fluid chamber 22 may be varied by varying the length of the fluid chamber.

The closure device cannot be operated to introduce the liquid additive 120 into the main liquid compartment 14 unless the anti-tamper strip 80, 455 is at least partially removed, thereby providing security to the consumer that the additive has not been mixed with the contents of the container prematurely, for example while sitting on a shelf in a shop.

The internal shape of the fluid chamber 22, which has a top surface 76 of the bottom wall 24 which slopes down towards the aperture 25 and plug member 42, ensures that only a minimum amount of residual liquid additive remains in the fluid chamber after release of the additive. Hence the closure device 10 can be removed and placed on a surface without significant deposition of additive on the surface. The sloping shape allows the full amount of liquid additive 120 to be delivered even if the container is tilted from the vertical during operation of the closure device to fire the additive.

The materials of the closure device can be selected to avoid any compatibility problems with the liquid additive 120. During storage the liquid additive is only in contact with the cap member 20 and the plug member 42. The plug member can be made separately from a different material to the remainder of the housing, if required. A liner, for example of stainless steel, can be used inside the fluid chamber to avoid contact with the moulded cap member 20, if required. Certain flavouring or colouring additives are not compatible with sealant materials. The bottom wall 24 can thus be manufactured, for example by inset moulding, so that the upper surface 76 of the bottom wall 24 is polypropylene or other suitable inert material, while the seals 64, 78 are protected below the material of the upper surface.

The closure device of the invention offers a simplified process for filling and assembling the closure device, and can be assembled and fitted to a container without the need for adhesive. The fluid chamber 22 can be easily pressurised, using any appropriate source of pressurised gas, which can simply fit to the nozzle 60 on the housing 40 once the closure device has been assembled. No specialised aerosol technology is necessary.

The liquid additive 120 can be denser or more viscous, and the area of the nozzle passage 61 and internal fluid passage 70 can be increased if required, to improve the flow of a more viscous additive. Additives which require shaking to dissolve them can be used with the closure device of the invention, since it permits shaking of the container after firing with no risk of spillage through between the closure device and container, because the closure device remains sealed to the neck.

The closure device remains in one piece when removed, and can be recyclable. Recyclability is improved if the closure and housing are made of the same material.

Modifications and variations are possible without departing from the scope of the invention. In addition to the modifications and variations described above, the liquid additive may be replaced by a gel or a free flowing powder or the like. The bottom wall 24 may be formed integrally with the remainder of the cap member 20. The closure member may be used with a container holding a carbonated beverage, providing the pressure of the main liquid compartment 14 is less than the pressure of the fluid chamber 22. The cam surfaces 271, 451 may be of any suitable design, and arranged so that the closure device fires, that is ejects the liquid additive 120 into the main liquid compartment 14, after any suitable angle of rotation, for example 45°, and allows removal of the closure device from the container after any suitable further angle of rotation, for example 270° to 450°.

1. A closure device for use with a container having a main liquid compartment and an opening with a neck,
the closure device comprising a cap member defining a fluid chamber and a housing having a plug member sealingly engageable in an aperture in a bottom wall of the fluid chamber;
wherein the housing includes
an outer housing wall adapted in use to engage with a neck of an opening of the container, and
an inner housing wall arranged inside the outer housing wall connected to the outer housing wall by a web;
wherein the cap member is provided with a cam means which engages with a corresponding cam means provided on an upper surface of the web of the housing to allow the cap member to be lifted relative to the housing from a closed position in which the plug member closes the aperture to an open position in which the plug member is at least partially withdrawn from the aperture to provide a communication path in use from the fluid chamber to the main liquid compartment.

2. A closure device according to claim 1, wherein the housing includes an inner housing wall adapted to fit inside the neck of the opening, and the closure device includes sealing means which seals between the fluid chamber and the inner housing wall.

3. A closure device according to claim 1, wherein the cam means on one of the cap member or housing includes a cam surface and the cam means on the other of the cap member or housing includes a follower for co-operation with the cam surface.

4. A closure device according to claim 3, wherein the cam surface is in the form of one or more inclined surfaces and the follower is in the form of one or more inclined surfaces, such that the cap member is lifted relative to the housing by rotation of the cap member relative to the housing.

5. A closure device according to claim 1, wherein the cap member includes a top cap wall on which is provided the cap member cam means, an outer cap wall and an inner cap wall extending from the top cap wall to the bottom wall and arranged inside the outer cap wall.

6. A closure device according to claim 5, wherein the cap member cam means is provided on a lower surface of the top cap wall between the outer cap wall and the inner cap wall.

7. A closure device according to claim 1, wherein the outer housing wall includes an internal secondary thread adapted in use to engage with an external secondary thread provided on the neck of the container.

8. (canceled)

9. (canceled)

10. A closure device according to claim 5, wherein the outer cap wall is provided with engagement means, which engages with corresponding engagement means provided in an external surface of the housing.

11. A closure device according to claim 10, wherein an outer housing wall of the housing is provided with a first engagement means which engages with the outer cap wall engagement means in the closed position and a second engagement means which engages with the outer cap wall engagement means in the open position.

12. A closure device according to claim 2, wherein the housing further comprises a frame which supports the plug member so that the plug member is arranged inside the inner housing wall and extends upwardly towards the fluid chamber in use.

13. A closure device according to claim 1, wherein the plug member includes a nozzle directed away from the fluid chamber.

14. A closure device according to claim 13, wherein the plug member includes a cylindrical outer surface which engages with a sealing means provided in the bottom wall.

15. A closure device according to claim 14, wherein the sealing means comprises an upper seal which seals against the cylindrical outer surface of the plug member when the cap member is in the closed position and which allows the passage of fluid between the upper seal and the plug member when the cap member is in the open position.

16. A closure device according to claim 15, wherein the sealing means comprises a lower seal which seals against the cylindrical outer surface of the plug member when the cap member is in the closed and open positions.

17. A closure device according to claim 16, wherein the plug member includes an internal fluid passage which extends to the cylindrical outer surface at a position below the upper seal when the cap member is in the closed position, the internal fluid passage being in communication with the nozzle.

18. A closure device according to claim 1, wherein the cap member includes an anti-tamper ring provided on the cap member to prevent rotation of the cap member relative to the housing without at least partial removal of the anti-tamper ring.

19. A closure device according to claim 18, wherein the anti-tamper ring comprises an extension of the outer cap wall connected to the outer cap wall by a perforated neck portion, the extension being provided with a flange which engages beneath the outer housing wall to prevent lifting of the cap member relative to the housing.

20. A closure device according to claim 1, wherein the cap member and housing cam means include mutually engageable detent means to prevent the rotation of the cap member relative to the housing beyond a predetermined limiting angle of rotation.

21. A container having a main liquid compartment, an opening having a neck, and a closure device closing said opening,
wherein the closure device comprises a cap member defining a fluid chamber and a housing secured to the neck of the container,
the housing including an outer housing wall which is adapted to engage with a neck, and an inner housing wall arranged inside the outer housing wall and connected to the outer housing wall by a web,
the housing having a plug member sealingly engageable in an aperture in a bottom wall of the fluid chamber,
wherein the cap member is provided with a cam means which engages with a corresponding cam means provided on an upper surface of the web of the housing to allow the cap member to be lifted relative to the housing from a closed position in which the plug member closes the aperture to an open position in which the plug member is at least partially withdrawn from the aperture to provide a communication path in use from the fluid chamber to the main liquid compartment.

22. A container according to claim 21, wherein the inner housing wall is inside the neck of the opening, and the closure device includes sealing means which seals between the fluid chamber and the inner housing wall.

23. A container according to claim 21, wherein the main liquid compartment contains a primary liquid and the fluid chamber contains an additive liquid and a head space of pressurised gas.

24. A method of assembling a closure device containing additive liquid for introduction into a main liquid compartment of a container, the method comprising
providing a cap member,
securing a bottom wall to said cap member to define a fluid chamber,
inverting the cap member and introducing an additive liquid into the fluid chamber through an aperture in the bottom wall,
providing a housing having an outer housing wall adapted in use to engage with a neck of an opening of the container, an inner housing wall arranged inside the outer housing wall and connected to the outer housing wall by a web, and a plug member,
attaching the housing to the cap member by relative axial movement of the housing and cap member so that the plug member enters and closes the aperture in the bottom wall of the fluid chamber, the relative axial movement of the housing and cap members being accomplished by co-operation between a cam surface on the web of the housing with a follower on the cap member.

25. A method of introducing an additive liquid into a main liquid compartment of a container, the method comprising the steps of:
raising by action of mutually engaging cam means a cap member of a closure device and a fluid chamber defined by said cap member relative to a housing, said housing including an outer housing wall adapted in use to engage with a neck of an opening of the container, and an inner housing wall arranged inside the outer housing wall and connected to the outer housing wall by a web on an upper surface of which is provided one of said mutually engaging cam means,
causing a plug member provided on said housing to move relative to the cap member from a closed position in which an aperture provided in a bottom wall of said fluid chamber is closed by said plug member to an open position in which the plug member is at least partially withdrawn from the aperture to provide a communication path from the fluid chamber to the main liquid compartment,
releasing pressurised liquid from said fluid chamber along said communication path into said main liquid compartment, and
rotating the cap member further to remove the cap member and housing from the container.

26. A method according to claim 25, wherein the closure member comprises:
a cap member defining a fluid chamber and a housing having a plug member sealingly engageable in an aperture in a bottom wall of the fluid chamber;
wherein the housing includes
an outer housing wall adapted in use to engage with a neck of an opening of the container, and
an inner housing wall arranged inside the outer housing wall connected to the outer housing wall by a web;
wherein the cap member is provided with a cam means which engages with a corresponding cam means provided on an upper surface of the web of the housing to allow the cap member to be lifted relative to the housing from a closed position in which the plug member closes the aperture to an open position in which the plug member is at least partially withdrawn from the aperture to provide a communication path in use from the fluid chamber to the main liquid compartment.

27. A method according to claim 25, wherein during the raising of the fluid chamber relative to the housing a seal is maintained between the fluid chamber and an inner housing wall of the housing arranged in the neck of the container.

28. A method according to claim 25, wherein the cap member is raised by rotating the cap member such that the fluid chamber is raised by cam action between a first cam means provided on the cap member and a second cam means provided on the housing.

29. A method according to claim 28, wherein the cap member is rotated by a first angle of between approximately 0° and 90° from the closed position to the open position.

30. A method according to claim 29, wherein further rotation of the cap member is limited to a second angle of between approximately 0° and 90° by the mutual engagement of detent means provided on the cap member and housing.
